(19) United States
(12) Patent Application Publication
(10) Pub. No.: US 2004/0107382 A1
(43) Pub. Date: Jun. 3, 2004

(54) METHOD FOR NETWORK LAYER RESTORATION USING SPARE INTERFACES CONNECTED TO A RECONFIGURABLE TRANSPORT NETWORK

(75) Inventors: Robert Duncan Doverspike, Tinton Falls, NJ (US); Kenneth A. Duell, Tinton Falls, NJ (US); Charles Robert Kalmanek JR., Short Hills, NJ (US); Guangzhi Li, Harrison, NJ (US); Panagiotis Sebos, New York, NY (US); Dongmei Wang, Harrison, NJ (US); Jennifer Yates, Morristown, NJ (US)

Correspondence Address: AT&T CORP., P.O. BOX 4110, MIDDLETOWN, NJ, 07748, US

(73) Assignee: ATT CORP., Middletown, NJ (US)

(21) Appl. No.: 10/604,471

(22) Filed: Jul. 23, 2003

Related U.S. Application Data
(60) Provisional application No. 60/319,421, filed on Jul. 23, 2002.

(51) Int. Cl. G06F 11/00

(52) U.S. Cl. 714/4

(57) ABSTRACT

The present invention utilizes spare restoration capacity in a re-configurable transport network to help recover from IP layer failures as well as to handle sudden bursts in IP traffic loads.

### CROSS REFERENCE TO RELATED APPLICATIONS

This application is a nonprovisional of U.S. Provisional Application “METHOD FOR NETWORK LAYER RESTORATION USING SPARE INTERFACES CONNECTED TO A RECONFIGURABLE TRANSPORT NETWORK,” Serial No. 60/319,421, filed on Jul. 23, 2002, the contents of which are incorporated by reference herein.

### BACKGROUND OF INVENTION

The present invention relates to telecommunication networks and more particularly to network layer failure recovery and traffic management in a telecommunication network.

Modern telecommunication networks are reconfigurable and should provide for fast restoration from network failures. Failure recovery in the context of networks of Internet Protocol (“IP”) routers is conventionally achieved utilizing IP layer routing protocols. Today's IP networks typically depend on link state routing protocols, such as Open Shortest Path First (OSPF) or Intermediate System-Intermediate System (IS-IS), to automatically re-route traffic in the event of network failures, such as IP router failures (including software failures and failures due to software upgrades), IP link failures, or IP interface failures. See, e.g., J. Moy, “OSPF Version 2,” IETF Network Working Group, RFC 2328 (April 1998); “Intermediate System to Intermediate System Intra-Domain Routing Exchange Protocol for use in Conjunction with the Protocol for Providing the Connectionless-mode Network Service (ISO 8473),” ISO DP 10589 (February 1990).

On the other hand, in the context of transport technologies such as optical networking, Synchronous Optical Network (SONET) rings have provided the primary technology for optical layer communication and restoration from failures. As optical layer cross connects (OLXCs) are deployed within today's transport networks based on wavelength-division multiplexing (WDM), the potential emerges to provide on-demand establishment of high-bandwidth connections. Novel mesh-based restoration techniques have been devised for such re-configurable optical transport networks. See “METHODS AND SYSTEMS FOR FAST RESTORATION IN A MESH NETWORK OF OPTICAL CROSS CONNECTS,” Ser. No. 09/474,031, filed on Dec. 28, 1999, which is incorporated by reference herein. Thus, as these re-configurable transport networks are deployed, IP network links may be routed over these networks. Optical layer failure recovery can then be used to handle problems in the transport network such as fiber cuts.

### SUMMARY OF INVENTION

An embodiment of the present invention emerges from the observation that a common pool of restoration resources can be shared by an IP network and a re-configurable transport network. In accordance with an embodiment of the invention, spare restoration capacity in a re-configurable transport network can be utilized to help recover from IP layer failures as well as to handle sudden bursts in IP traffic loads. Spare IP interfaces at a router can be connected to a re-configurable transport network, such as a network of optical cross connects, as a means of providing rapid failure recovery from IP link, interface and node failures and to provide additional bandwidth to routers to handle surges in IP link loads. Dynamic capacity allocation using optical network resources can be used to handle traffic surges that result from increases in user traffic, failures, or changes in peering relationships with other service providers.

In accordance with an embodiment of the invention, a hybrid architecture is disclosed which routes service links of the IP layer directly over a transport layer (such as a WDM layer), bypassing the re-configurable transport network, and utilizing the idle capacity within the re-configurable transport network—typically reserved for failures or new demand within the network—to bring up additional (temporary) links in the IP layer as needed. This advantageously incurs little or no additional cost for transporting such additional, temporary links in the IP layer.

In accordance with another embodiment of the invention, where IP links are routed over the re-configurable transport network, coordination between the IP and transport networks can be utilized to provide interface protection for the IP router. This can prove particularly important for access router ports, which are currently a single point of failure within IP networks.

The present invention provides simpler, alternative mechanisms for handling failures and traffic surges within an IP network compared with today's state-of-the-art. By taking advantage of a hybrid architecture of IP layer and transport technologies, the present invention advantageously can improve network performance while reducing overall network cost. The present invention provides a solution that can result in significant cost reductions and faster restoration over existing IP layer restoration.

These and other advantages of the invention will be apparent to those of ordinary skill in the art by reference to the following detailed description and the accompanying drawings.

### BRIEF DESCRIPTION OF DRAWINGS

FIG. 1 is a diagram of a hybrid network architecture, illustrating an embodiment of the present invention.

FIG. 2 illustrates a router failure in the network shown in FIG. 2.

FIG. 3 is a diagram of a network illustrating failure recovery of links not routed over a re-configurable transport network, as triggered by failure detection.

FIG. 4 is a flowchart of processing performed in failure recovery, in accordance with an embodiment of the invention.

FIG. 5 is a diagram of a network illustrating “1:N” interface protection for links routed over a re-configurable transport network, as triggered by failure detection.

FIG. 6 is a flowchart of processing performed in interface failure protection, in accordance with an embodiment of the invention.

FIG. 7 is a flowchart of processing performed in handling traffic surges, in accordance with an embodiment of the invention.

### DETAILED DESCRIPTION

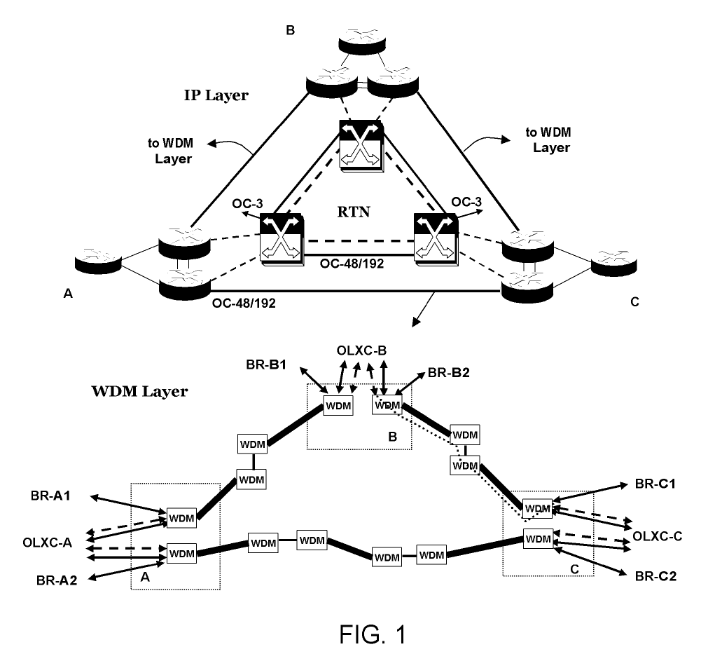

FIG. 1 is a conceptual diagram of a hybrid network architecture, illustrating an embodiment of the present invention. A plurality of Internet Protocol (“IP”) routers are depicted in the IP layer of FIG. 1. In the IP layer, the active links between the routers are represented as black solid lines. The dashed lines, on the other hand, connect spare IP interfaces, e.g. typically plug-in integrated circuit cards on the routers, to what the inventors refer to as a re-configurable transport network (“RTN”). These spare interfaces are normally in an inactive or unconfigured state with respect to the IP layer, and no connectivity is provided through the RTN. Instead, the spare interfaces advantageously can be connected via the RTN to form new links at the IP layer as needed—and then returned to their inactive, unconfigured state when no longer needed.

The RTN depicted in FIG. 1 comprises, for example and without limitation, optical layer cross-connects (OLXCs) that can dynamically route connection requests between its add/drop interfaces. The OLXC may be, for example, an opto-electronic cross-connect that switches according to port and time slot, or may be an all-optical device that switches entire wavelengths or fibers. The links between the OLXCs are carried over a Wavelength Division Multiplex (WDM) layer, as shown in FIG. 1, that, typically, has no automatic re-configurability. The links of the RTN are typically composed of channels (e.g., SONET STS-nc (n×52.8 Mb/sec) for electrically-based OLXCs or wavelengths for optically-based OLXCs. Connections (such as DS3 (45 Mb/sec) or STS-n signals) can be routed over the RTN by cross-connecting the appropriate bundle of channels between coincident links of an OLXC. In the example shown in FIG. 1, lower rate connections, such as OC-3, are routed over (in-service) channels of the solid links in the RTN. Some of these links will have idle channels. For example, OC-48 or OC-192 links that are totally comprised of idle channels are depicted in FIG. 1 by the dark dashed links in the RTN. The dotted line shown in the WDM layer illustrates how the idle (dashed) link between OLXC-B and OLXC-C routes over the WDM layer. Idle channels are placed on the links of the RTN network and serve two purposes: to support new lower-rate connection requests or to support connection restoration in the event of a failure within the transport network. For example, this idle channel capacity can provide extra, typically mesh-based, restoration for failures of connections routed over the RTN links. See, e.g., U. S. Utility patent application, “METHODS AND SYSTEMS FOR FAST RESTORATION IN A MESH NETWORK OF OPTICAL CROSS CONNECTS,” Ser. No. 09/474,031, filed on Dec. 28, 1999, which is incorporated by reference herein. The present invention allows the restoration channel capacity in the RTN to be used more flexibly and with less impact to the IP layer when RTN restoration capacity needs to be used for failures in the RTN.

Although depicted in FIG. 1 and described herein particularly in the context of optical networking, the invention can be readily appreciated by those of ordinary skill in the art to apply to other transport and cross-connect technologies in general.

The interfaces from the IP layer or RTN to the WDM layer are illustrated at the WDM layer shown in FIG. 1. As depicted in FIG. 1, the IP layer links are shown as being routed directly over the WDM layer, i.e. directly over point-to-point Optical Transport Systems (“OTSs”) that do not support dynamic reconfiguration. Although depicted in FIG. 1 as such, it should be noted that other variations of this hyrbid design are possible—such as routing the IP layer links over the RTN—as further described herein.

The basic architecture shown in FIG. 1 can be utilized in the context of a number of different applications. The triggering mechanisms for creating (or activating) new IP layer links, for example, can be: 1) by failure or alarm detection or 2) by detection of increases in traffic loads over a prescribed threshold on the IP links, referred to herein as traffic surges. Sudden surges in traffic on IP links can occur for many reasons, including IP layer link or router failures, or sudden increases in traffic loads due to changes in user behavior (e.g., changes in IP peering points/traffic, flash crowds etc). Thus, one application of the present invention is to target, for example and without limitation, the following types of events:

1. creating/activating new IP links to restore the IP layer from IP link failures (from failures in the RTN, WDM, or fiber layers);

2. creating/activating new IP links to restore the IP layer from individual IP card failures;

3. creating/activating new IP links to restore the IP layer from total router failure; and/or

4. creating or activating new IP links due to changes in traffic patterns.

It should be noted that traffic surges can be used as a detection mechanism for all four types of events; however, alarm/failure detection mechanisms can only be used for the first three types of events.

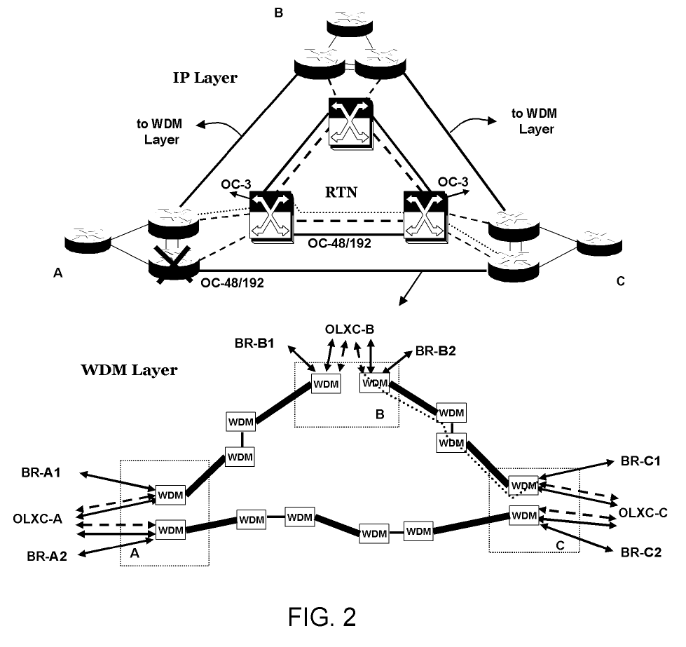

FIG. 2 gives an example of this application. In this example the links of the IP network that are designed to carry traffic during non-failure conditions are directly routed over the WDM layer, thus skipping the RTN. Routing an IP link directly over the WDM layer is less expensive than routing it over the RTN. In the event of a failure of one of the WDM directly-routed IP links, a new link is dynamically established between the affected pair of routers using spare interfaces connected to the RTN. As mentioned above, the triggering mechanism for failures in the network could be either failure detection (such as loss of signal, loss of frame or internal router detection of failed line cards) or detection of traffic surges. FIG. 2 illustrates this triggering mechanism for a node failure of the example network shown in FIG. 1. In this example, the BR-A1 Backbone Router (BR) fails. The Access Router (AR) at A discovers the outage and reconfigures its routing tables to route all traffic over BR A2. If BR A2 detects a sufficiently large traffic surge from this rerouting, then knowledge of the failure and the sudden increase in traffic loads can be combined to deduce that the sudden traffic increase is unlikely to be a very short-term transient event and that the new capacity is required to alleviate the congestion. BR A2 requests a new link between A2 and C2 (or C1) from the RTN. As shown, the RTN routes the new IP link over the channels of the dashed link (with idle channels) between OLXCs at A and C. Although the traffic surge mechanism is more generic and universal, failure detection methods tend to be more rapid in their detection of failures. The hybrid architecture shown in FIG. 2 is most cost effective when the IP layer uses a mixture of permanent links and reconfigurable links. A novel aspect of this invention is that some or all of the extra capacity needed to protect router failures at the IP layer can be more economically provided via re-configurable links that use idle restoration capacity in the RTN. This approach is beneficial because transport of these links is essentially “free” since it utilizes the idle capacity required in the RTN to restore lower rate services. This capacity is also termed “pre-emptible” capacity since a connection assigned for a reconfiguration connection between IP routers would be disconnected if the capacity were needed to restore connections that were disrupted due to a failure in the RTN. A key assumption in the invention is that the network is designed so that the joint probability of both router failure and RTN link failure (for which insufficient pre-emptible capacity remains) is sufficiently small. This is an extreme example of “shared mesh restoration”, wherein restoration capacity is shared by non-simultaneous events. In this case, restoration capacity is shared between failures that could occur in different layers of the network.

Variations on the ideas described above are further expanded on below, in particular with regard to the different detection methods and the different IP link activation methods that can be utilized.

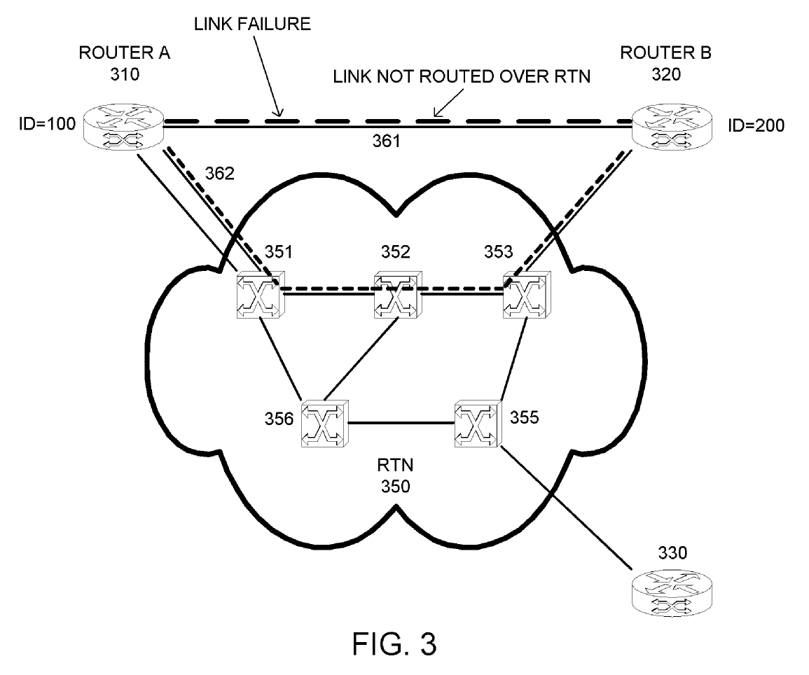

1. Failure recovery of IP links not routed over RTN (triggered by failure detection). In the event of a failure of one or more IP links that are directly routed over the WDM layer (i.e., not routed over OLXCs), the IP routers at either end of the link(s) affected by the failure can detect the failure and establish new connections over the reconfigurable transport network between the spare interfaces on the affected routers. FIG. 3 illustrates this variation. FIG. 3 depicts a link routed over the WDM layer for which the IP link fails and is recovered via the re-configurable transport network 350. The dashed line 361 represents the failed link routed directly over WDM, whilst the dotted line 362 represents the new connection established over the RTN 350 using the spare IP router interfaces.

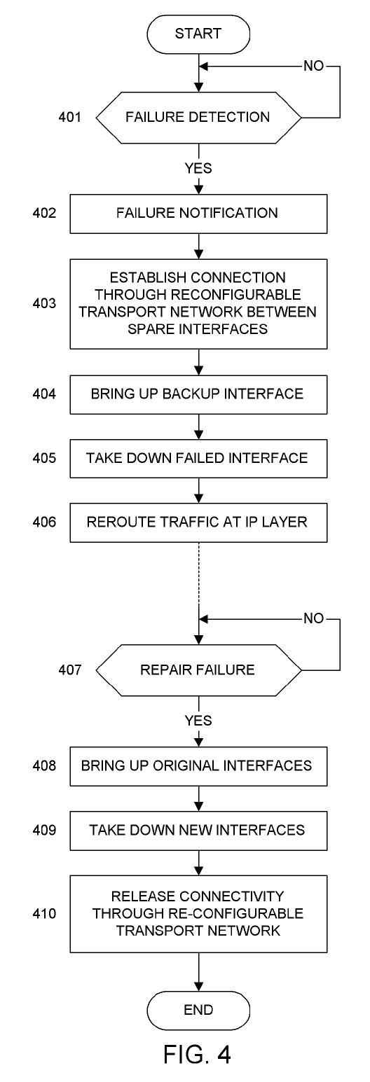

FIG. 4 sets forth a flowchart of processing performed in failure recovery, in accordance with an embodiment of this aspect of the invention. At step 401, a failure is detected, using any of a range of failure detection mechanisms, depending on the type of failure. For a fiber cut, for example, failure detection can be achieved by the router line cards detecting loss of signal (LOS) or loss of frame (LOF). Router interface failures can be detected either via detection of CRC errors or internally within a router through keep-alive messages or interrupts between the central processor and the line cards. Alternatively, traditional keep-alive messages between adjacent routers (e.g., the “hellos” used in OSPF) can be used to detect the failure of an entire link. If both ends of the link simultaneously detect the failure, only one end should respond to establish the new connectivity. A simple convention such as the router with the highest node ID (node IP address) should be used to determine which router is responsible for establishing the new link. Routers can determine their adjacent router's node IDs through routing protocols, such as OSPF. In the example in FIG. 3 above, router B (320) has the highest node ID and is thus responsible for establishing a new connection to router A (310). Upon detection of a failure, at step 402, router A will notify router B of the failure, but will not itself establish a connection. The notification can be left to the physical link layer (e.g., through Ethernet Remote Fault Indications or SONET AISs), or can be achieved through a standardized IP layer message, such as the RSVP and CR-LDP notification messages introduced in the OIF UNI and GMPLS. See, e.g., B. Rajagopalan, ed., “User Network Interface (UNI) 1.0 Signaling Specification,” OIF 2000.125.07; L. Berger, ed., et al., “Generalized MPLS Signaling—RSVP-TE Extensions,” IETF Network Working Group, Internet Draft, http://www.ietf.org/internet-drafts/draft-ietf-mpls-generalized-rsvp-te-07.txt (April 2002); P. Ashwood-Smith, ed., et al., “Generalized MPLS Signaling—CR-LDP Extensions,” IETF Network Working Group, Internet Draft, http://www.ietf.org/internet-drafts/draft-ietf-mpls-generalized-cr-ldp-06.txt (April 2002); which are incorporated by reference herein.

Once a failure has been detected, a new IP link can be established at step 403 by requesting a connection to be created over the RTN. The connection can be established either via communications between IP and transport management systems (OSSs), or via signaling over the User to Network Interface (UNI) between the router (e.g., router B) and the cross-connect to which the router is physically connected. If the connection is to be established using the optical network restoration capacity, then the UNI or OSS should indicate that the established connection is a restoration connection so that the RTN can handle the bandwidth allocation accordingly. The OIF UNI 1.0 can achieve this through definition of appropriate service classes—e.g., defining a service class that denotes that the RTN should use idle (spare) restoration capacity.

Finally, at step 404, the new interfaces are brought into operation, and, at step 405, the failed interfaces are taken out of service. At step 406, the traffic is re-routed at the IP layer. Accordingly, in addition to achieving the new connection between the two routers, the router interfaces should also be configured and routing tables reconfigured. How this is achieved depends on the routing and interface address assignment mechanisms used at a router. If a router is using unique IP addresses at each interface for routing, then the new interfaces can be assigned the addresses of the failed interfaces. This requires that both ends of a link be aware of which addresses to use—this can be controlled by adding a new attribute to the UNI and RTN signaling which carries the IP address of the remote interface transparently across the UNI and the RTN to the router at the other end of the link. Using the original IP addresses on the new link has the desirable property of being able to avoid routing updates in the IP routing protocols in response to the failure and the establishment of the new IP link. When the new link is established, the routing and forwarding tables within the routers on either end of the link must be reconfigured to forward packets out of the new interface instead of the old one. The failed interfaces should then be taken out of operation (i.e., taken “down”).

Once the failure has been repaired, at step 407, the original interfaces should be brought back into operation (brought up) at step 408, and the routing and forwarding tables should be updated with the original interfaces to re-route traffic over the original interface. At step 409, the new interfaces should be taken out of service (taken down), and the connectivity through the transport network should be released at step 410. Alternatively, the new interfaces can be taken down before bringing up the original interfaces; however, this ordering of the procedure would result in significant user traffic being lost.

A similar approach can be used for unnumbered interfaces, in which the locally unique interface identifiers of the new interfaces are replaced by those used on the failed interfaces.

Composite links aggregate multiple component links into a single logical link for routing purposes. See, e.g., U.S. Pat. No. 6,359,879, “COMPOSITE TRUNKING,” to Carvey et al., which is incorporated by reference herein. Individual physical links and their associated router interfaces are configured as being part of a given composite link. Composite links lie below layer 2/3 routing and hide the component links from routing protocols by aggregating them into a single logical link. Thus, since load balancing of packets onto the individual links of a composite link is handled in real time from the source interfaces, the removal or addition of a link from/to a composite link has virtually no impact on lost packets and is not seen within IP routing or forwarding mechanisms. Using this approach, when a link/interface fails within a given composite link, the spare interfaces are configured as being part of the composite link for which they are replacing. No routing updates need be generated as a result of the change in participants of the composite link, thus presumably resulting in faster failure recovery. When a failed link or interface is repaired, it can be included back within its original composite link, and then the replacement interfaces can be removed.

Finally, IP tunneling, MPLS or other tunneling mechanisms can also be used. For example, IP tunnels can be established over each physical interface. We consider an example with GRE. In this case, the IP routing layer uses GRE tunnel addresses in the next-hop part of the routing table, rather than using physical interface addresses. Each GRE tunnel address is mapped to a physical interface address during normal operation. In the event that the router brings in a new interface in response to a failure as above, the GRE tunnel addresses associated with the failed physical interfaces are mapped to the new physical interfaces, which can be achieved transparent to IP routing. When the original link/interfaces are repaired, the tunnels are mapped back to the original interfaces. Similarly, with MPLS, the MPLS labels are mapped to different physical interfaces according to which interface is active.

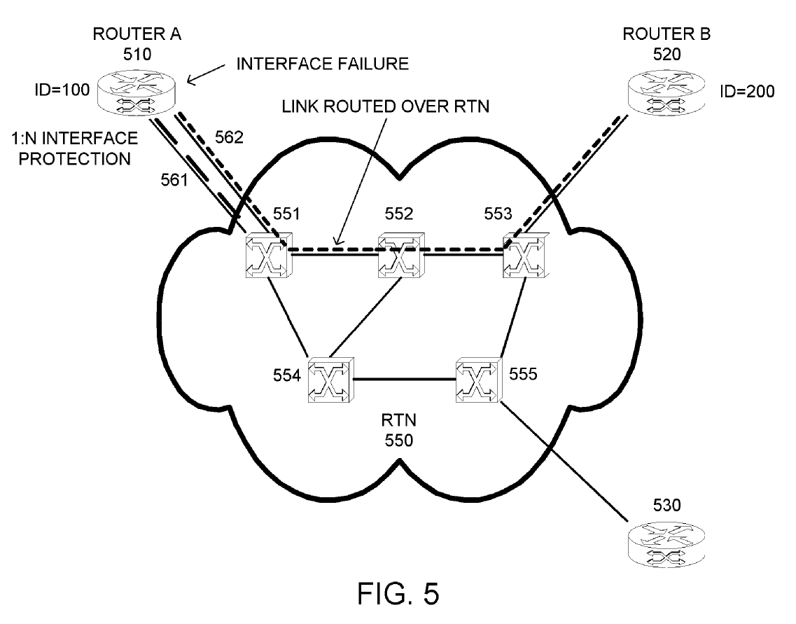

2. Failure recovery of IP links routed over RTN (triggered by failure detection): 1:N IP interface protection. In the event of an IP interface failure of a link interconnecting the IP interface to a neighboring cross-connect, the IP router with the failed interface can switch to a spare interface. This involves cross-connection at the neighboring cross-connect to switch the new IP interface into the existing connection between the two routers. FIG. 5 illustrates this variation. Unlike the embodiments illustrated above, the IP links in FIG. 5 are routed over the RTN 550. The dashed line 561 between the IP router 510 and the OLXC 551 indicates the connectivity of the failed interface, while the dotted line 562 illustrates the working connection. In the event of a failure within the RTN 550, a number of techniques, including RTN restoration, could be used to re-establish connectivity of all of the affected IP links. In the event of a failure of a router interface, drop-side OLXC port, or the link interconnecting the two, the existing connection is switched to a new interface—thereby achieving “1:N” interface protection between the router interface and the OLXC port.

Router interface protection may be particularly important on access router ports, which are currently a single point of failure within IP networks.

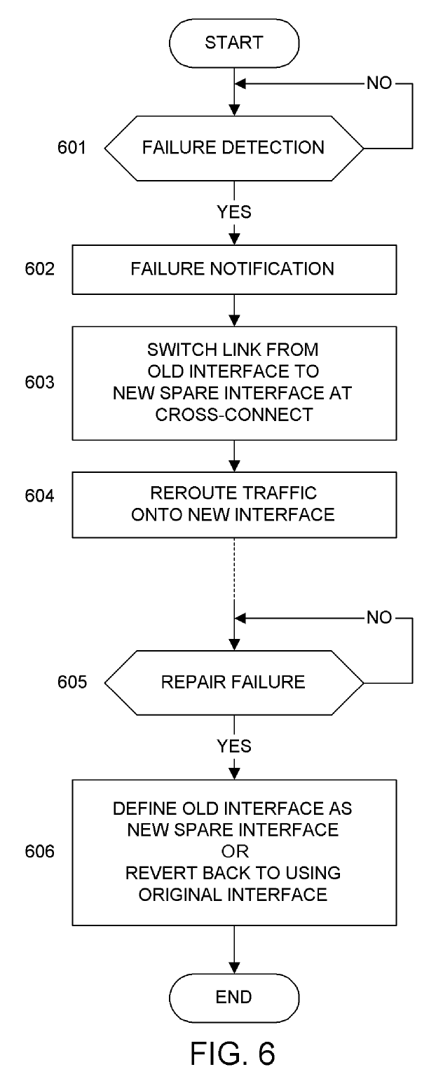

FIG. 6 sets forth a flowchart of processing performed in interface failure protection, in accordance with an embodiment of this aspect of the invention. At step 601, a failure is detected, using any of a range of failure detection mechanisms, depending on the type of failure. For a failure of the connecting-fiber between the router and the neighboring OLXC, for example, failure detection can be achieved by the router line cards or OLXC detecting LOF or LOS. Router interface failures can be identified via CRC checks or internally within a router through keep-alive mesages or interrupts between the central processor and the line cards. If the OLXC detects the failure, then, at step 602, it can send a failure notification to the router either via the physical link layer (e.g., through Ethernet Remote Fault Indications or SONET AISs), or through a standardized UNI message, such as the RSVP and CR-LDP notification messages used within the OIF UNI.

Once a failure has been detected, the OLXC needs to switch the link in question from the old interface to the spare interface replacing it at step 603. The protection switching can be initiated by either the router or the OLXC, although in general it would make sense to have IP (either router or IP OSS) responsible for port selection and requesting protection switching. The protection switching request can be communicated either between IP and transport OSSs, directly between IP and transport network elements (i.e., routers and OLXCS) via signaling over the UNI, or between an OSS and a NE (e.g., IP router and transport OSS), again via UNI signaling. The OIF UNI would be a natural candidate for the signaling between IP and transport—for example, the IP router (e.g., router A in FIG. 5) could use the OIF UNI to signal to either its directly connected OLXC (shown) or to the transport OSS (not shown). OIF UNI 1.0 could be extended to support this application by using the existing connection request message with the original connection ID (i.e., the connection ID of the established connection) with a different port number (i.e., describing the new interface port). For example, in RSVP-TE this involves sending an RSVP refresh with a different port number. Alternatively, a new modification message can be introduced into the UNI that, among other applications, can be used to indicate that the connection should be switched from the old port to the new port. This message should involve interactions only between the router and the local OLXC, and should not be propagated through the optical network and to the router at the other end of the link. Thus, the combination of Modify messages with the appropriate parameters should prompt the transport NEs to keep the operation local. Then, interface protection using the UNI could be used in situations in which the original (failed) connection was not originally established via the UNI and does not require that both ends of an IP link be UNI-enabled (e.g., if the other end of the link is a customer router).

The new router ports can be assigned the same IP addresses (for numbered links) or local identifiers (for unnumbered links) as were used on the interfaces on the failed link to avoid routing updates in IP routing protocols. Once the protection switching has been completed, the routing and forwarding tables within the router must be reconfigured to forward packets out of the new interface instead of the old ones, at step 604. The failed interfaces should be taken out of operation (i.e., taken “down”) to avoid duplicate addresses when the failure is repaired.

Once the failure has been repaired, at step 605, the router may continue to use the new interface and define the old interface as the new spare interface, or it may revert back to using the original interface, at step 606. Reverting back to the old interface involves taking the new interface out of operation (taking it down), bringing the original interface back into operation (bringing it up) and switching back the connectivity through the transport network (achieved using the same approach as for switching upon failure). Note that this involves taking a hit in user traffic.

Other techniques such as composite links or tunneling mechanisms (e.g., IP tunneling or MPLS) can also be used to eliminate the need for routing updates in routing protocols. These were described above for failure recovery of IP links not routed over the RTN. Using GRE as an example of IP tunneling, the IP routing layer uses GRE tunnel addresses in the next-hop part of the routing table, rather than using physical interface addresses. The procedure is similar to that described above.

3. Link routed or not routed over RTN (triggered by traffic surge). Sudden surges in traffic on IP links can occur for many reasons, including IP layer link or router failures, or sudden increases in traffic loads due to changes in user behavior (e.g., changes in IP peering points/traffic, flash crowds etc). These surges can be detected using surge detection algorithms, and a new connection(s) is established over the RTN between the same pair of routers as the surging link to provide additional capacity.

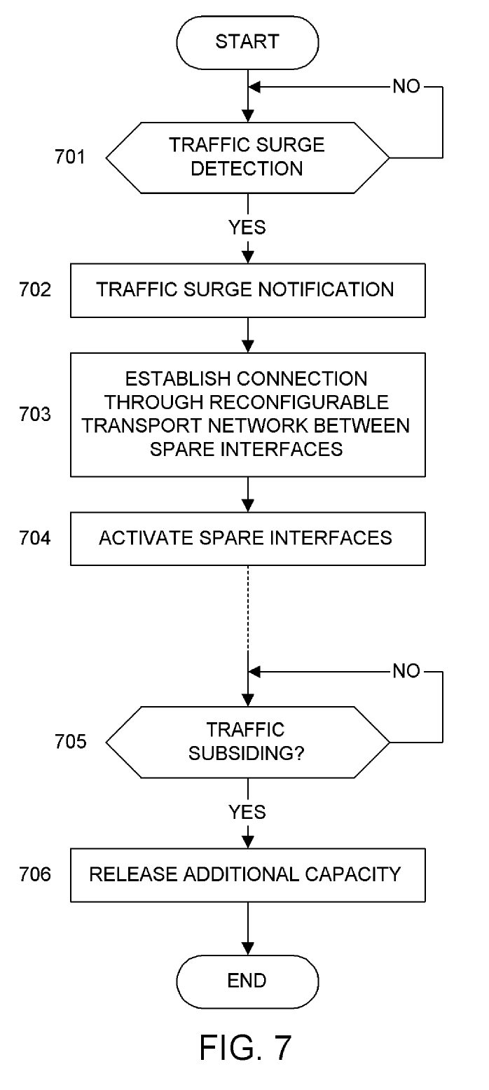

FIG. 7 sets forth a flowchart of processing performed in handling traffic surges, in accordance with an embodiment of this aspect of the invention. At step 701, sudden increases in traffic loads are detected, for example via a simple threshold function measuring link loads. If the threshold is exceeded over a pre-defined period of time, then a new connection is initiated. More sophisticated surge detection criteria can also be used. If both ends of the link simultaneously detect the surge, only one end should respond to initiate the new connectivity. A simple convention such as the router with the highest node ID (router IP address) should be used to determine which router is responsible for establishing the new link. Routers can determine their adjacent router's node IDs through routing protocols, such as OSPF or IS-IS. Upon detection of a surge, the router with the lower node ID will notify the router with the higher node ID of the surge at step 702, but will not itself initiate establishment of connectivity. The notification can be achieved through a standardized IP layer message, such as the RSVP and CR-LDP notification messages introduced in the OIF UNI and GMPLS. See above.

When a surge has been detected and a decision to establish a new link made, a new connection is established over the RTN at step 703. The connection can be initiated either via communications between IP and transport OSSs, or via signaling over the User to Network Interface (UNI) between the router and the cross-connect to which the router is physically connected. The connection can be established using the optical network restoration capacity—then the UNI or IP OSS should indicate this so that the RTN can handle the bandwidth allocation accordingly. The router communication via OIF UNI 1.0 can achieve this through carrier definition of appropriate service classes—e.g., defining a service class that denotes that the RTN should use spare restoration capacity.

In addition to establishing the new link between a pair of routers, the routers also need to activate the router interfaces at step 704. This may involve providing the router interfaces with new IP addresses. If point-to-point IP links are used, then any IP address can be used on the interfaces and the coordination can be achieved through existing routing protocols. If broadcast addresses are used, then the IP addresses assigned to the two ends of the link must be selected appropriately. The end initiating the new link can select the IP addresses, and signal it to the destination router by adding a new attribute into the UNI and RTN signaling which carries the IP address of the remote interface transparently across the RTN to the router at the other end of the link.

Alternatively, composite links can be used to hide the addition/deletion of capacity to links from routing protocols such as OSPF, as described above.

When the load subsides on the links, at step 705, the additional capacity should be released, at step 706. This requires mechanisms to detect the reduction in load, and mechanisms for releasing the capacity. Similar algorithms can be used to detect the reduction in load as are used for surge detection (e.g., detect the load going below a given threshold for a certain period of time). Once this has been detected, the router can inform the RTN that the capacity should be released. This communication is again achieved either via OSS communication, or via UNI signaling (e.g., using the delete request from the OIF UNI). The corresponding router interfaces are then taken out of operation (brought down). Their IP addresses may optionally be “released” (particularly if broadcast addresses are used).

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the detailed description describes an embodiment of the invention with particular reference to IP and optical networking technologies. However, the principles of the present invention could be readily extended to other transport technologies and protocols. Such an extension could be readily implemented by one of ordinary skill in the art given the above disclosure.

1. A method of operating an internet protocol (IP) network comprising a plurality of routers, each router further comprising a plurality of interfaces, the method comprising the steps of:
connecting a spare interface on a first router in the IP network to a re-configurable transport network which provides connectivity to a spare interface on a second router in the IP network;
upon detection of a pre-designated condition in the IP network, switching traffic designated for a primary interface at the first router to the spare interface at the first router in the IP network, thereby causing the traffic to flow across spare capacity on the re-configurable transport network between the spare interface on the first router and the spare interface on the second router in the IP network.

2. The method of claim 1 wherein the pre-designated condition is a failure in the primary interface at the first router in the IP network.

3. The method of claim 2 wherein the primary interface provided connectivity to the re-configurable transport network before failure and wherein the spare interface provides 1:N interface protection.

4. The method of claim 2 wherein the primary interface provided connectivity over a direct point-to-point link and wherein the spare interface provides dynamic establishment of a new IP link in response to the failure.

5. The method of claim 1 wherein the pre-designated condition is a surge in traffic across the primary interface at the first router in the IP network.

6. The method of claim 1 wherein the re-configurable transport network comprises a plurality of optical cross-connects.

7. A device-readable medium storing program instructions for performing a method of operating a router in an Internet Protocol (IP) network, the router further comprising a routing table and a plurality of interfaces including a spare interface providing connectivity through a re-configurable transport network to a spare interface on a second router in the IP network, the method comprising the steps of:
receiving a signal indicating a pre-designated condition in the IP network;
reconfiguring the routing table in the router so as to switch traffic designated for a primary interface at the router to the spare interface at the router, thereby causing the traffic to flow across spare capacity on the re-configurable transport network between the spare interface on the router and the spare interface on the second router in the IP network.

8. The device-readable medium of claim 7 wherein the pre-designated condition is a failure in the primary interface at the first router in the IP network.

9. The device-readable medium of claim 8 wherein the primary interface provided connectivity to the re-configurable transport network before failure and wherein the spare interface provides 1:N interface protection.

10. The device-readable medium of claim 8 wherein the primary interface provided connectivity over a direct point-to-point link and wherein the spare interface provides dynamic establishment of a new IP link in response to the failure.

11. The device-readable medium of claim 7 wherein the pre-designated condition is a surge in traffic across the primary interface at the first router in the IP network.

12. An Internet Protocol (IP) router comprising:
a plurality of interfaces including at least one primary interface and a spare interface providing connectivity through a re-configurable transport network to a spare interface on a second router in an IP network;
a routing table that, upon receipt at the router of a signal indicating a pre-designated condition in the IP network, is reconfigured so as to switch traffic designated for a primary interface at the router to the spare interface at the router, thereby causing the traffic to flow across spare capacity on the re-configurable transport network between the spare interface on the router and the spare interface on the second router in the IP network.

13. The router of claim 12 wherein the pre-designated condition is a failure in the primary interface at the first router in the IP network.

14. The router of claim 13 wherein the primary interface provided connectivity to the re-configurable transport network before failure and wherein the spare interface provides 1:N interface protection.

15. The router of claim 13 wherein the primary interface provided connectivity over a direct point-to-point link and wherein the spare interface provides dynamic establishment of a new IP link in response to the failure.

16. The device-readable medium of claim 12 wherein the pre-designated condition is a surge in traffic across the primary interface at the first router in the IP network.
